(19) United States
(12) Patent Application Publication
(10) Pub. No.: US 2019/0330067 A1
(43) Pub. Date: Oct. 31, 2019

(54) WET-MILLED AND DRIED CARBONACEOUS SHEARED NANO-LEAVES

(71) Applicant: Imerys Graphite & Carbon Switzerland Ltd., Bodio (CH)

(72) Inventors: Sergio PACHECO BENITO, Biasca (CH); Raffaeie GILARDI, Bellirszona (CH); Flavio MORNAGHINI, Breganzona (CH); Simone ZÜRCHER, Origllo (CH); Michael SPAHR, Bellinzona (CH)

(21) Appl. No.: 16/332,041

(22) PCT Filed: Sep. 12, 2017
(86) PCT No.: PCT/EP2017/072943

§ 371 Date: Mar. 11, 2019

(30) Foreign Application Priority Data
Sep. 12, 2016 (EP) 16188344.2

(51) Int. Cl. C01B 32/225; C08K 3/04; H01M 4/62; H01M 4/90; H01M 4/92; H01M 4/96; B02C 13/02; C08F 210/02; C08F 210/06; F16D 63/00; B02C 17/08; B02C 19/18; H01M 10/0525

(52) U.S. Cl. CPC C01B 32/225; C01P 2004/51; C08K 3/046; H01M 4/625; H01M 4/9083; H01M 4/926; H01M 4/96; B02C 13/02; C08F 210/02; C08F 210/06; F16D 63/00; B02C 17/08; B02C 19/18; H01M 10/0525; C01P 2004/24; C01P 2004/50; C01P 2006/11; C01P 2006/12; C01P 2006/40; F16D 2200/0073; C01P 2004/04; C08K 3/041

(57) ABSTRACT

The present disclosure relates to wet-milled and dried carbonaceous sheared nano-leaves generally characterized by a BET SSA of less than about 40 m²/g and a bulk density from about 0.005 to about 0.04 g/cm³, and compositions comprising such carbonaceous sheared nano-leaves. The present disclosure further relates to methods for preparing them, and their use as a conductive additive in composites such as polymer blends, ceramics, and mineral materials, or as solid lubricant.

### FIELD OF THE DISCLOSURE

The present disclosure relates to carbonaceous sheared nano-leaves and compositions comprising them, to methods for preparing them, and their use as a conductive additive in composites such as polymer blends, ceramics, and mineral materials, or as solid lubricant.

### BACKGROUND

Carbonaceous materials such as graphite powder are a well-known conductive filler (i.e., additive) for thermally and electrically conductive polymers and other composite materials.

Expanded or exfoliated graphite, also known as nanographite or nano-structured graphite has recently attracted increased interest because of its excellent thermal and electrical conductivity properties. Expanded graphite outperforms non-expanded graphite and other conductive fillers (e.g., boron nitride, carbon fibers, or carbon nanotubes) in terms of the thermal conductivity conveyed to polymers or other materials such as cement or gypsum-based materials. For example, adding expanded graphite to flooring materials to increase the thermal conductivity of the composite material is generally known in the art and has been described in, e.g., DE 100 49 230 A1.

However, disadvantages of adding expanded graphite—as opposed to conventional highly crystalline synthetic and natural graphite—to the polymer mass are its difficult workability and processability (inter alia caused by its high surface area), its lower oxidation resistance, and its dustiness due to its low bulk density. For example, the rather high surface area of expanded graphite combined with a rather low bulk density will practically limit the amount of carbonaceous material that can be added to the polymer (or other matrix materials having low thermal conductivity on their own) in view of the increased viscosity during the compounding process. Accordingly, the viscosity problems observed with increasing amounts of carbonaceous material lead to a practical limit for the thermal conductivity achievable in a composite material containing a given graphite (and polymer). Moreover, it is known in the art that highly exfoliated carbonaceous material, also known as graphene, can have very high surface areas (theoretically >2600 m²/g (Ref. Nanoscale, Vol. 7, Number 11, Pages 4587-5062) when it is completely exfoliated (i.e. mono-layer graphene) therefore increasing even further the viscosity of the mixture in a composite containing that given graphene.

EP 0 981 659 B describes a method for making expanded graphite from lamellar flake graphite which after conventional expansion includes an air milling step to delaminate the exfoliated flake graphite particles. The air-milled exfoliated flake graphite product has a specific surface area of at least 18 m²/g, a mean particle size of 30 microns, and a bulk volume of at least 20 ml/g.

US 2002/0054995 A1 describes graphite nanostructures in the form of platelets with an aspect ratio of at least 1,500:1, with a specific surface area of typically 5 to 20 m²/g, an average size of typically 10 to 40 μm and an average thickness of less than 100 nm (typically 5 to 20 nm). The nanoplatelets are prepared by wet milling natural or synthetic graphite particles in a high-pressure flaking mill. US 2002/0054995 A1 states that the graphite nanostructures have a unique geometric structure that cannot be obtained with exfoliated graphite.

US 2014/0339075 A1 discloses compositions containing conductive particles as a filler, which may be an exfoliated graphite containing substantially no single layer graphene, or may be a mixture of single layer graphene and by-products of a process used to partially convert graphite into single layer graphene. Examples of exfoliated graphites that can be used include milled graphite, expanded graphite, and graphite nanoplatelets. While the non-exfoliated graphites described in this application have a surface area of at least 10 m²/g, graphite nanoplatelets have a specific surface area of well above 100 m²/g.

WO 2012/020099 A1 describes graphite agglomerates comprising ground expanded graphite particles compacted together, wherein said agglomerates are in granular form having a size ranging from about 100 μm to about 10 mm, a tap density ranging from about 0.08 to about 1.0 g/cm³, and a specific surface area of typically between 15 and 50 m²/g. The agglomerated particles are prepared from expanded graphite that has subsequently been ground by milling (such as air milling) and then compacted to form “soft” agglomerates that dissolve when compounded into a polymer.

EP 3 050 846 A1 discloses a graphene composite powder which is composed of graphene materials and a high-molecular compound. The high-molecular compound is uniformly coated on surfaces of the graphene material. An apparent density of the graphene composite powder form material is larger than or equal to 0.02 g/cm³.

US 2015/0210551 A1 discloses graphite nanoplatelets, having a BET surface area of from about 60 to about 600 m²/g, produced by a process which comprises thermal plasma expansion of intercalated graphite, where greater than 95% of the graphite nanoplatelets have a thickness of from about 0.34 nm to about 50 nm and a length and width of from about 500 nm to about 50 microns.

WO 2015/193268 A1 relates to a process for producing graphene nanoplatelets, comprising expanding flakes of intercalated graphite and collection of the same in a dispersing medium with forming of a dispersion that is subjected to exfoliation and size reduction treatment carried out by high pressure homogenization in a high shear homogenizer. A dispersion of graphene is obtained in the form of nanoplatelets, at least 90% of which have a lateral size (x, y) from 50 to 50,000 nm and a thickness (z) from 0.34 to 50 nm.

US 2008/258359 A1 describes a method of exfoliating a layered graphite material to produce separated nano-scaled platelets having a thickness smaller than 100 nm. The method comprises: (a) providing a graphite intercalation compound comprising a layered graphite containing expandable species residing in an interlayer space of the layered graphite; (b) exposing the graphite intercalation compound to an exfoliation temperature lower than 650° C. for a duration of time sufficient to at least partially exfoliate the layered graphite without incurring a significant level of oxidation; and (c) subjecting the at least partially exfoliated graphite to a mechanical shearing treatment to produce separated platelets.

U.S. Pat. No. 8,222,190 B2 describes a lubricant composition comprising: (a) a lubricating fluid; and (b) nano graphene platelets (NGPs) dispersed in the fluid, wherein nano graphene platelets have a proportion of 0.001% to 60% by weight based on the total weight of the fluid and the graphene platelets combined.

US 2014/335985 A1 relates to a sliding element for use in a chain transmission apparatus, comprising a sliding contact section for engagement in sliding contact with a chain, wherein the sliding contact section consists of a plastic material comprising a matrix polymer and dispersed therein graphite platelets comprising platelet particles having a thickness of at most 250 nm.

In Lubricants 2016, 4, 20, Gilardi examined the effect of various graphite-containing polystyrene (PS) composite materials on the friction coefficient, the wear resistance, and the PV limit of PS by tribological tests (“ball-on-three-plates” tests).

Accordingly, it would be advantageous to provide alternative carbonaceous materials that show improved properties, particularly when used as a conductive additive, with regard to conveying excellent electrical, thermal conductivity and/or mechanical properties to the composite materials comprising these carbonaceous materials. It would also be advantageous to provide further applications and uses for these carbonaceous materials, e.g., as a filler for polymers, for battery and capacitor electrodes, electrically and/or thermally conductive polymer composite materials such as automotive body panels, brake pads, clutches, carbon brushes, powder metallurgy, fuel cell components, catalyst support, lubricating oils and greases or anticorrosion coatings.

### SUMMARY OF THE INVENTION

Thus, according to a first aspect, the present disclosure is directed to carbonaceous sheared nano-leaves in particulate form, wherein said carbonaceous sheared nano-leaves can be characterized by a BET SSA of less than about 40 m²/g, or from about 10 to about 40 m²/g, or from about 12 to about 30 m²/g, and a bulk density from about 0.005 to about 0.04 g/cm³, or from about 0.006 to about 0.035 g/cm³, or from about 0.07 to about 0.030 g/cm³.

According to a second aspect, the present disclosure is directed to a process for making the carbonaceous sheared nano-leaves particles of the present disclosure, wherein the method comprises

(a) mixing expanded graphite particles with a liquid to give a pre-dispersion comprising expanded graphite particles;
(b) subjecting the pre-dispersion obtained from step a) through a milling step; and
(c) drying the carbonaceous sheared nano-leaves particles obtained from milling step b).

Carbonaceous sheared nano-leaves in particulate form obtainable by the above method thus represent a further aspect of this disclosure.

A fourth aspect of the present disclosure relates to compositions comprising the carbonaceous sheared nano-leaves particles described herein, optionally together with other carbonaceous materials such as natural graphite, primary or secondary synthetic graphite, expanded graphite, coke, carbon black, carbon nanotubes such as single-wall (SWCNT) or multi-wall (MWCNT) carbon nanotubes, carbon nanofibers, or mixtures thereof, and the like.

In a fifth aspect, the present disclosure provides dispersions comprising the carbonaceous sheared nano-leaves particles described herein.

A sixth aspect of the present disclosure refers to composite materials comprising the carbonaceous sheared nano-leaves particles as described herein together with a polymer, lithium nickel manganese cobalt oxide (NMC), manganese dioxide (MnO₂), gypsum or other matrix materials whose thermal or electrical conductivity alone is not sufficient. Another related aspect relates to electrode materials for batteries (including lithium ion batteries and primary batteries), and capacitors, batteries, including lithium ion and primary batteries, vehicles containing a battery, including a lithium ion battery and a primary battery, or engineering materials (such as brake pads, clutches, carbon brushes, fuel cell components, catalyst supports and powder metallurgy parts). comprising the carbonaceous sheared nano-leaves as described herein.

A further aspect of the disclosure relates to a dispersion comprising the carbonaceous sheared nano-leaves in particulate form as described herein. Such dispersions are typically liquid/solid dispersions of the carbonaceous sheared nano-leaves in a suitable solvent such as water or water/alcohol mixtures (optionally mixed with additives or binders).

Yet another aspect of the disclosure concerns the use of the carbonaceous sheared nano-leaves material as an additive for polymers, electrodes, functional materials, car body panels, or brake pads.

Finally, a further aspect of the present disclosure refers to the use of ground expanded graphite, including the carbonaceous sheared nano-leaves material as described herein as a lubricant for dry film lubricant materials, e.g. in electrical materials, automobile engines and metal parts, or as an additive to reduce friction and/or wear in composite materials.

### BRIEF DESCRIPTION OF THE DRAWINGS

FIG. 1 illustrates the ratio of BET specific surface area to apparent (bulk) density for various carbonaceous sheared nano-leaves materials according to the present disclosure and of comparative carbonaceous materials.

FIG. 2 plots the BET specific surface area versus the dry D90 value to apparent (bulk) density ratio for various carbonaceous sheared nano-leaves materials according to the present disclosure and of comparative carbonaceous materials.

FIGS. 3a to 3d show SEM pictures of unmilled expanded graphite (3a), air-milled expanded graphite (3b), high-pressure milled and spray dried expanded graphite.

FIG. 4 shows the thermal conductivity of a polystyrene (PS) composite material comprising 20 wt % of carbonaceous sheared nano-leaves as an additive (samples 11, 12 and 13) and of PS composite polymers comprising 20% of some comparative carbonaceous graphitic materials.

FIG. 5 plots the limiting force (defined herein as the normal force where the friction coefficient exceeds 0.3 in a balls-on-three-plates test) against the observed through-plane thermal conductivity for different PS composite polymers comprising 20 wt % of carbonaceous sheared nano-leaves as an additive (samples 11, 12 and 13 encircled) and of PS composite polymers comprising 20 wt % of other carbonaceous materials (same materials as shown in FIG. 4).

FIG. 6 plots the friction coefficient as a function of normal force for PA6.6 balls on polystyrene (PS) plates at a fixed rotational speed of 500 rpm in dry conditions for different PS composite polymers comprising 20 wt % of carbonaceous sheared nano-leaves as an additive (samples 11, 12 and 13) and of PS composite polymers comprising 20 wt % of other carbonaceous materials (C-Therm002, C-Therm301).

FIG. 7 plots the friction coefficient as a function of normal force for steel balls on polystyrene (PS) plates at a fixed rotational speed of 1500 rpm in dry conditions for different PS composite polymers comprising 20 wt % of carbonaceous sheared nano-leaves as an additive (samples 11, 12 and 13) and of PS composite polymers comprising 20 wt % of other carbonaceous materials (C-Therm002, C-Therm301).

### DETAILED DESCRIPTION

### Carbonaceous Sheared Nano-Leaves in Particulate Form

The inventors have surprisingly found that wet-milling of expanded (exfoliated) graphite under carefully controlled conditions leads to a carbonaceous material that can be described as carbonaceous sheared nano-leaves having a relatively low surface area and also having a relatively low bulk density, i.e. carbon particles with a geometry of thin platelets obtainable through shearing-off of nanolayers from the expanded graphite particles along the c-axis through the wet milling process.

Such carbonaceous sheared nano-leaves particles inter alia exhibit improved handling and material properties as compared to conventional expanded graphite or commercial exfoliated graphite and/or graphene, particularly when the additive is blended into a polymer, when used as a component of electrodes (e.g. for lithium ion batteries or for primary batteries), or as a lubricant. These sheared nano-leaves thus provide excellent electrical and thermal conductivities to composite materials comprising them and allow, among other things, reasonably high loading levels when used as a conductive additive in polymer or other matrix materials without causing processability problems (e.g. due to high viscosity during compounding). However, due to their excellent electrical and thermal properties, in many cases a lower content of the carbonaceous material will be necessary to achieve the same electrical and/or thermal conductivity, compared to many expanded graphite or commercial exfoliated graphite and/or graphene materials known in the art.

Moreover, it has been found that carbonaceous sheared nano-leaves, as well as other ground expanded graphite materials can be advantageously used as a solid lubricant additive in composite materials, or as dry film lubricant in various industrial applications, for example to reduce friction and wear in moving machine components in engines or other mechanical systems such as ball-bearings, and the like.

The term “nano” in the present context refers to carbonaceous platelets which have a thickness in the crystallographic c direction of less than 1 μm, and is typically much less, such as below 500 nm, or below 200 nm, or even below 100 nm. Due to their flaky, highly anisotropic character, i.e. very thin platelets, and low apparent densities, the carbonaceous sheared nano-leaves particles (also referred to herein as “carbonaceous sheared nano-leaves” and “carbonaceous sheared nano-leaves in particulate form”) may be considered as “few layer graphene” or “graphite nanoplatelets”, with an optimized ratio of (relatively low) specific surface area and low apparent (i.e. bulk) density that has been found to provide certain advantages in the target applications.

Thus, according to a first aspect, the present disclosure is directed to carbonaceous sheared nano-leaves in particulate form, wherein said carbonaceous sheared nano-leaves graphite is characterized by a BET SSA of less than about 40 m²/g, or from about 10 to about 40 m²/g, or from about 12 to about 30 m²/g, or from about 15 to about 25 m²/g, and by a bulk (i.e. Scott) density from about 0.005 to about 0.04 g/cm³, or from about 0.005 to about 0.038 g/cm³, or from about 0.006 to about 0.035 g/cm³, or from about 0.08 to about 0.030 g/cm³; or any possible combination of the two parameters BET SSA and bulk density set out above.

In some embodiments, the carbonaceous sheared nano-leaves are further characterized by a particle size distribution having a D₉₀ ranging generally from about 5 to about 200 μm, or from about 10 to about 150 μm. In some instances, the D₉₀ value may range from about 15 to about 125 μm, or from 20 μm to about 100 μm. It will be understood that these PSD values relate to the primary, i.e. non-agglomerated particles. In agglomerated carbonaceous nano-leaves—which represent another possible embodiment of the present disclosure as described in more detail below—the PSD values will of course be different, and typically, much larger. However, upon deagglomeration, the primary particles will have a PSD with a D₉₀ in the range set out above. The same is true for the bulk density, which typically increases upon agglomeration. However, as with the PSD, the bulk density of de-agglomerated, primary particles will fall in the range set out above.

Alternatively or in addition, the carbonaceous sheared nano-leaves may be further characterized by a dry PSD D₉₀ to apparent density ratio of between about 5000 to 52000 μm*cm³/g, or between about 5500 and 45000, or between about 6000 and 40000 μm*cm³/g.

Certain embodiments of the carbonaceous sheared nano-leaves of the present disclosure may be further characterized by a thickness (i.e. height of the stack of sheets along the c-axis), as determined by transmission electron microscopy (TEM), of generally ranging from about 1 to about 30 nm, or from about 2 to 20 nm, or from 2 to 10 nm. In some cases, the thickness of the carbonaceous sheared nano-leaves particulates will be in the range of from about 3 to 8 nm.

The carbonaceous sheared nano-leaves may in some embodiments be further characterized by a xylene density ranging from about 2.0 to about 2.3 g/cm³, or from about 2.1 to about 2.3 g/cm³.

Alternatively or in addition, the carbonaceous sheared nano-leaves may in some embodiments be further defined by an L_{c} value of below about 100 nm, preferably below about 80, 70, 60, or 50 nm, and/or by a Raman I_{D}/I_{G} ratio of below about 0.5, preferably below about 0.4, 0.3, or 0.2.

The carbonaceous sheared nano-leaves of the present disclosure may also be characterized by certain physicochemical properties they convey to composite materials comprising said nano-leaves at a defined loading level. Thus, in certain embodiments, the carbonaceous sheared nano-leaves can be, alternatively or in addition, be characterized by any one of the following parameters:

i) conveying an electrical resistivity to manganese dioxide comprising 2% by weight of said carbonaceous sheared nano-leaves of generally below about 1000 mΩ cm, or of below about 900, 800, 700, 600, 500 or 400 mΩ cm; and/or
ii) conveying an electrical resistivity to polypropylene comprising 4% by weight of said carbonaceous sheared nano-leaves of below about 10¹⁰ n cm, preferably below about 10⁸, 10⁷, 10⁶, 10⁵ or 10⁴ Ωcm; and/or
iii) conveying an electrical resistivity to lithium nickel manganese cobalt oxide (NMC) comprising 2% by weight of said carbonaceous sheared nano-leaves of below about 20 Ωcm, preferably below about 15, 10, 8, 6, 5, 4, or 3 Ωcm; and/or
iv) conveying a through plane thermal conductivity to polystyrene (PS) comprising 20% by weight of said carbonaceous sheared nano-leaves of above about 1 W/mK, preferably above about 1.05, 1.10, 1.15, 1.20, 1.25 W/mK; and/or
v) conveying a friction coefficient to polystyrene (PS) comprising 20% by weight of said carbonaceous sheared nano-leaves of below 0.45, preferably below about 0.40, 0.35, or 0.30 when measured in a “balls-on-three-plates” test with steel balls at 1500 rpm at a normal force of 35 N; and/or (vi) conveying a limiting force to polystyrene (PS) comprising 20% by weight of said carbonaceous sheared nano-leaves of at least 33 N, or at least 34, 35, 36, or 37 N when measured in a “balls-on-three-plates” test with steel balls at 1500 rpm at increasing normal force.

In certain embodiments, the carbonaceous sheared nano-leaves may be obtainable by milling expanded graphite particles in the presence of a liquid (i.e. wet milling) and subsequent drying of the dispersion under conditions so as to achieve the desired BET SSA and bulk density and optionally any of the other parameters as defined above.

As already briefly noted above, certain parameters, such as BET SSA, PSD or bulk density relate to the carbonaceous sheared nano-leaves in an essentially non-agglomerated form.

However, it is also envisaged that the carbonaceous sheared nano-leaves according to the present disclosure may also be agglomerated (e.g. after the wet-milling process and subsequent to the drying of the primary particles). Those of skill in the art will understand that agglomerated carbonaceous sheared nano-leaves according to the present disclosure may, due to their agglomeration, have different characteristic parameters tha primary carbonaceous sheared nano-leaves, i.e. in an essentially non-agglomerated form.

Thus, in another aspect of the present disclosure, the carbonaceous sheared nano-leaves may be present in an agglomerated form. Such agglomerates may be characterized by a bulk density of typically more than 0.08 g/cm³, or more than 0.1 g/cm³. In some embodiments of this aspect, the carbonaceous sheared nano-leaves in an agglomerated form may have a bulk density ranging from about 0.1 to about 0.6 g/cm³, or from about 0.1 to about 0.5 g/cm³, or from about 0.1 to about 0.4 g/cm³. Alternatively or in addition, the agglomerated carbonaceous sheared nano-leaves may be characterized by a PSD having a D₉₀ ranging typically from about 50 μm to about 1 mm, or from about 80 to 800 μm, or from about 100 to about 500 μm.

The agglomerated nano-leaves are typically “soft” agglomerates, i.e. they “dissolve” into primary particles in their target applications, e.g. when added to a polymer during compounding.

In any event, it will be understood that de-agglomeration of such “soft” agglomerates will yield primary carbonaceous sheared nano-leaves particles that exhibit the physicochemical parameters as described herein above for non-agglomerated particles.

### Processes for Making Carbonaceous Sheared Nano-Leaves in Particulate Form

As briefly mentioned above, the carbonaceous sheared nano-leaves according to the present disclosure may be prepared by a wet-milling process of expanded (i.e. exfoliated) graphite, as will be described herein in more detail.

In particular, the milling in the presence of a liquid, i.e. where the graphite particles to be milled are present as a suspension, is a relatively non-invasive treatment which does not, or not significantly increase the specific surface area (BET SSA) or the bulk density of the resulting nano-leaves material. Moreover, the apparent (bulk) density of the wet-milled expanded graphite powder will either be maintained, or is even somewhat increased compared to the starting material. Unmilled expanded graphite has a vermicular (“worm-like”) structure with a very low bulk density.

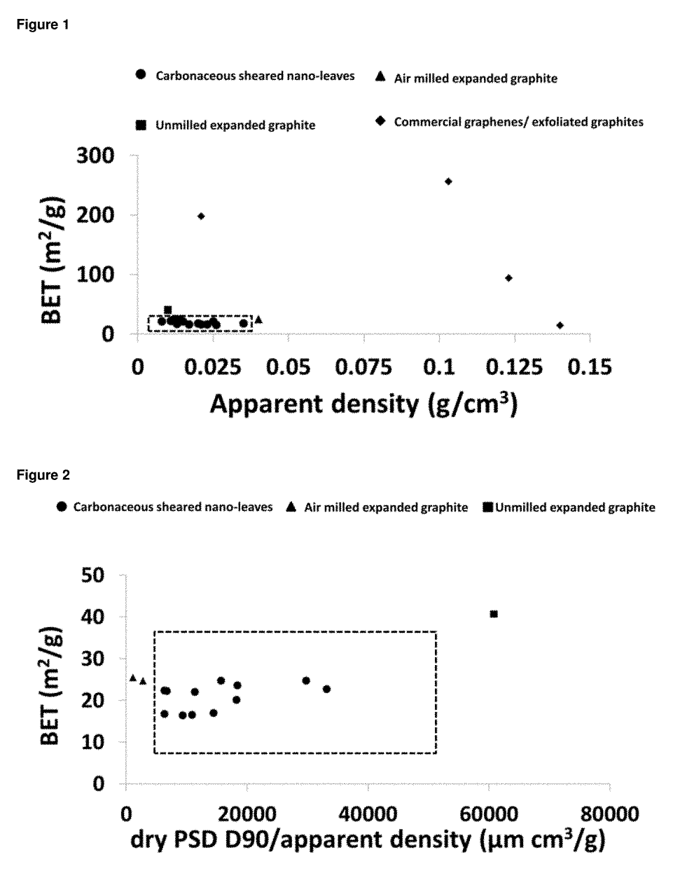

FIG. 1 illustrates the bulk density and specific surface area of various carbonaceous sheared nano-leaves samples in comparison to comparative materials, showing that the nano-leaves according to the present disclosure all fall within a relatively limited range that has, to the best of applicant's knowledge, not been described in the art. Such carbonaceous sheared nano-leaves can be obtained by adjusting the parameters of the wet-milling step and subsequent drying process, dependent on things like the starting material, or the equipment used for the wet-milling and drying process. Suitable processes for obtaining the carbonaceous sheared nano-leaves as defined herein will thus be presented in more detail below.

Accordingly, another aspect of the present disclosure relates to a process for producing the carbonaceous sheared nano-leaves particles as defined herein, which comprises the following steps:
a) mixing expanded graphite particles with a liquid to give a pre-dispersion comprising expanded graphite particles;
b) subjecting the pre-dispersion from step a) through a milling step,
c) drying the carbonaceous sheared nano-leaves particles recovered from said milling step b).

In certain embodiments of this aspect, the process for producing the carbonaceous sheared nano-leaves particles further comprises, prior to steps a) to c) as set out above, subjecting a non-expanded carbonaceous material to a mixing and milling step, optionally according to the steps a) and b) above, and subsequently expanding said pre-milled carbonaceous material. In other words, the wet milling of expanded graphite may in some instances be preceded by a premixing and milling step before expanding (exfoliating) the graphite. The pre-mixing and milling may also be carried out several times, if necessary. Moreover, the step of expanding milled (i.e. ground) carbonaceous material may in some cases also be repeated multiple times before subjecting the expanded graphite to the mixing and wet-milling steps a) and b) as set out above.

Given that graphite is insoluble in about any liquid, there is generally no limitation on the liquid used for preparing the pre-dispersion. However, it is clear that the viscosity of the liquid should not be too high as this would prevent or hamper the formation of a homogenous dispersion of the graphite particles to be milled. Thus, in many embodiments, the liquid used in step a) (and step b)) is selected from water, an organic solvent, or mixtures thereof. When an organic solvent is used, this solvent should not be hazardous for the environment. Hence, alcohols such as ethanol, isopropanol, propanol, butanol, or esters such as acetone or other non-toxic/non-hazardous organic solvents such as N-methyl-2-pyrrolidone (NMP) are preferred. When used as a mixture with water, the organic solvent should be water miscible to prevent the formation of a two (or three) phase system.

While the amount of solvent, and thus the solid concentration of the dispersion is not really limited as a matter of principle, it will be understood that the solids content should not exceed certain values because of the observed viscosity increase of the resulting dispersion (which in turn changes the dynamics of the wet-milling process). Accordingly, the content of the expanded graphite to be milled may typically range from about 0.2 wt % to about 20 wt %, although it is preferred that the solids content does not exceed 5% or even 3% by weight, unless a surfactant/wetting agent and/or a dispersant is added to the dispersion. Thus, in some embodiments the weight content is between about 0.2% and about 5%, or between about 0.5% and 3%, while in other embodiments the weight content of the expanded graphite to be milled will be between about 1% and 10%, or between about 2% and 8, or between about 3 and 6% % when a surfactant and/or a dispersant is added to the dispersion. Suitable dispersants/surfactants include, but are not limited to PEO-PPO-PEO block copolymers such as Pluronic PE 6800 (BASF AG), ionic dispersants like sulfonates such as Morwet EFW (AkzoNobel), or non-ionic dispersants like alcohol polyethoxylates such as Emuldac AS 25 (Sasol), alkyl polyethers such as Tergitol 15-S-9 (Dow Chemical), polyethylene glycols, or any other dispersants known to skilled persons in the field of pigment dispersion. The dispersant/surfactant makes up between about 0.01 wt % and about 10 wt % of the dispersion, and preferably between about 0.1 wt % and about 5.0 wt % of the dispersion, and most preferably between about 0.25 wt % and about 1.0 wt % of the dispersion.

The process may principally be carried out in any mill that can process dispersions containing the carbonaceous starting material described herein (i.e. typically expanded graphite). Suitable examples for mill types that can be used in wet-milling step b) include, but are not limited to, planetary mills, bead mills, high pressure homogenizers, or tip sonicators.

For example, the expanded graphite pre-dispersion may be fed, continuously or batch-wise, to a planetary mill in recirculation mode using for example ceramic balls as grinding media, and the processed dispersion may be collected after a specified time, or after a number of passes. Planetary mills comprise typically four small drums containing the beads and the carbonaceous material to be processed. They rotate in opposite direction to the bigger drum that harbors the four smaller drums. Rotating speeds typically vary from 500 to 1000 rpm and the ball diameter can vary typically from 1 to 10 mm.

When using a bead mill for the wet-milling step b), the expanded graphite pre-dispersion may be fed, continuously or in batch-mode, to a bead mill in recirculation mode using, for example ceramic beads as grinding media, and the processed dispersion may subsequently be collected after a specified time, or after a number of passes. In bead mills, a pin-based rotor stator is typically filled with beads rotating at speeds varying from 500 to 1500 rpm while the bead diameter can vary typically from 0.1 to 3 mm.

When using a high pressure homogenizer for the wet-milling step b), the expanded graphite pre-dispersion may be fed, continuously or in batch-mode, to a high pressure homogenizer that typically uses different valves and impact rings to generate a high pressure for homogenizing the dispersion in recirculation mode, and the processed dispersion may subsequently be collected after a specified time, or after a number of passes. Typically, the combination of the valves and impact rings together with the flow can create pressures inside the homogenizer of between 50 and 2000 bar.

When using a tip sonicator for the wet-milling step b), the expanded graphite pre-dispersion may be fed, continuously or in batch-mode, to a tip sonicator that creates high local pressures and cavitation by rapidly vibrating a metallic tip immersed in the dispersion in recirculation mode, followed by collecting the processed dispersion after a specified time, or after a number of passes.

In some embodiments, the wet milling step b) may be carried out multiple times, i.e. removing the milled material and subjecting it to another round of milling), until the desired parameters of the resulting material are achieved. If carried out multiple times, it is also possible to employ different mill types for the multiple wet-milling step. Alternatively, the multiple steps are all carried out in the same type of mill. Multiple milling steps may thus be carried out in a planetary mill, a bead mill, a high pressure homogenizer, a tip sonicator or combinations thereof.

In some embodiments, additional liquid may be added prior to the drying step, in order to dilute the processed expanded graphite dispersion. Suitable liquids may again be chosen from the list of suitable liquids given above. Preferably, the additional liquid is selected from water, organic solvents or mixtures thereof.

As regards step c), the drying is accomplished by any suitable drying technique using any suitable drying equipment. Typically, the first step of the drying (or, alternatively, the last step of milling step b)) is recovering the solid material from the dispersion, for example by filtration or centrifugation, which removes the bulk of the liquid before the actual drying takes place. In some embodiments, the drying step c) is carried out by a drying technique selected from subjecting to hot air/gas in an oven or furnace, spray drying, flash or fluid bed drying, fluidized bed drying and vacuum drying.

For example, the dispersion may be directly, or optionally after filtering the dispersion through a suitable filter (e.g. a <100 μm metallic or quartz filter), introduced into an air oven at typically 120 to 230° C., and maintained under these conditions, or the drying may be carried out at 350° C., e.g., for 3 hours. In cases where a surfactant is present, the carbonaceous sheared nano-leaves may optionally be dried at higher temperatures to remove/destroy the surfactant, for example at 575° C. in a muffle furnace for 3 hours.

Alternatively, drying may also be accomplished by vacuum drying, where the processed expanded graphite dispersion is directly, or optionally after filtering the dispersion through a suitable filter (e.g. a <100 μm metallic or quartz filter), introduced, continuously or batch-wise, into a closed vacuum drying oven. In the vacuum drying oven, the solvent is evaporated by creating a high vacuum at temperatures of typically below 100° C., optionally using different agitators to move the particulate material. The dried powder is collected directly from the drying chamber after breaking the vacuum.

Drying may for example also be achieved with a spray dryer, where the processed expanded graphite dispersion is introduced, continuously or batch wise, into a spray dryer that rapidly pulverizes the dispersion using a small nozzle into small droplets using a hot gas stream. The dried powder is typically collected in a cyclone or a filter. Exemplary inlet gas temperatures range from 150 to 350° C., while the outlet temperature is typically in the range of 60 to 120° C.

Drying can also be accomplished by flash or fluid bed drying, where the processed expanded graphite dispersion is introduced, continuously or batch wise, into a flash dryer that rapidly disperses the wet material, using different rotors, into small particles which are subsequently dried by using a hot gas stream. The dried powder is typically collected in a cyclone or a filter. Exemplary inlet gas temperatures range from 150 to 300° C. while the outlet temperature is typically in the range of 100 to 150° C.

Alternatively, the processed expanded graphite dispersion may be introduced, continuously or batch-wise, into a fluidized bed reactor/dryer that rapidly atomizes the dispersion by combining the injection of hot air and the movement of small media beads. The dried powder is typically collected in a cyclone or a filter. Exemplary inlet gas temperatures range from 150 to 300° C. while the outlet temperature is typically in the range of 100 to 150° C.

Drying can also be accomplished by freeze drying, where the processed expanded graphite dispersion is introduced, continuously or batch wise, into a closed freeze dryer where the combination of freezing the solvent (typically water or water/alcohol mixtures) and applying a high vacuum sublimates the frozen solvent. The dried material is collected after all solvent has been removed and after the vacuum has been released.

The drying step may optionally be carried out multiple times. If carried out multiple times, different combinations of drying techniques may be employed. Multiple drying steps may for example be carried out by subjecting the wet-milled nano-leaves to hot air (or a flow of an inert gas such as nitrogen or argon) in an oven/furnace, by spray drying, flash or fluid bed drying, fluidized bed drying, vacuum drying or any combination thereof.

In some embodiments, the drying step is conducted at least twice, preferably wherein the drying step comprises at least two different drying techniques selected from the group consisting of subjecting to hot air in an oven/furnace, spray drying, flash or fluid bed drying, fluidized bed drying and vacuum drying.

As shown in the Example section below, good results have for example been achieved by using the following, non-limiting, combinations of milling and drying methods:

planetary milling combined with spray drying
sonication combined with spray drying;
sonication combined with spray drying and air furnace drying;
high pressure homogenization combined with spray drying,
high pressure homogenization combined with spray drying and air furnace drying,
high pressure homogenization combined with vacuum drying,
high pressure homogenization combined with freeze drying,
high pressure homogenization combined with fluidized bed drying,
bead milling combined with spray drying,
bead milling combined with air furnace drying;
bead milling combined with spray drying and air furnace drying; or
bead milling combined with flash drying.

In general, the starting material used for the process according to the present disclosure is an expanded (i.e. exfoliated) graphite, that may be unground or pre-ground prior to the wet milling process described herein. Typically, the expanded graphite exhibits an apparent (bulk or Scott) density in the range of about 0.003 to 0.050 g/cm³ and a BET SSA from about 20 to about 200 m²/g.

As explained herein above, the resulting carbonaceous sheared nano-leaves may subsequently be agglomerated to produce “soft” agglomerates that typically have an increased bulk density compared to the non-agglomerated primary particles. Thus, in some embodiments the process for producing the carbonaceous sheared nano-leaves particles may further comprise an compaction step where the carbonaceous sheared nano-leaves obtained from drying step c are converted into agglomerates. In general, any compaction method can be used for such an agglomeration. Suitable compaction/agglomeration methods have for example been disclosed in the International application published as WO 2012/020099 A1, which are incorporated herein by reference in their entirety.

In certain embodiments, the compaction step (i.e., agglomeration) can be accomplished by a process employing a roller compactor. For example a suitable device is the Roller Compactor PP 150, manufactured by Alexanderwerk AG, Remscheid, Germany. Preferably, the ground expanded graphite particles are fed with the help of a screw to a couple of counter-rotating rolls to yield a pre-agglomerate, followed by a fine agglomeration step whereby the pre-agglomerates are pushed through a sieve which assists in defining the desired agglomerate size. In alternate embodiments, the agglomeration is accomplished by a process employing a flat die pelletizer, described for example in DE-OS-343 27 80 A1. In this process the tap density is adjusted by the gap between the rolls, the die and die size, and the speed of the rotating knives. Preferably, the ground expanded graphite particles are pressed through a die by pan grinder rolls, followed by cutting the pre-agglomerated graphite particles to the desired size with suitable means such as rotating knives. In yet another alternative process embodiment, the agglomeration is achieved by a process employing a pin mixer pelletizer or a rotary drum pelletizer (cf. FIG. 18). Several patents describe these pelletizer systems for the agglomeration of different types of powders, for example U.S. Pat. Nos. 3,894,882, 5,030,433, and EP 0 223 963 B1. In these process variants, the tap density is adjusted by the feeding rate, the moisture content, the choice and concentration of the additives and the pin shaft or drum rotating speed, respectively. In yet other alternative embodiments of the method, the agglomeration is accomplished by a fluidized bed process, by a spray dryer process or by a fluidized bed spray dryer process.

Another aspect of the present disclosure relates to carbonaceous sheared nano-leaves in particulate form as defined herein, which are obtainable by the process as described hereinabove and the appended claims.

### Compositions Comprising Carbonaceous Sheared Nano-Leaves Particles

In a further aspect, the present disclosure provides compositions comprising the carbonaceous sheared nano-leaves particles as described herein.

In some embodiments of this aspect, the composition may comprise mixtures of carbonaceous sheared nano-leaves particles as defined herein, wherein the particles are different from each other, e.g. made by a different process or with different starting materials (yet still satisfy the limitations set out herein). The compositions may in other embodiments furthermore, or alternatively, comprise other unmodified (e.g. natural or synthetic graphite) or modified carbonaceous, e.g. graphitic or non-graphitic particles. Thus, compositions comprising carbonaceous sheared nano-leaves particles according to the present disclosure with other carbonaceous or non-carbonaceous materials, in various ratios (e.g. from 1:99 to 99:1 (wt %) are also contemplated by the present disclosure. In certain embodiments, carbonaceous materials such as natural graphite, primary or secondary synthetic graphite, expanded graphite, coke, carbon black, carbon nanotubes, including single-wall (SWCNT) and multi-wall (MWCNT) carbon nanotubes, carbon nanofibers and mixtures thereof may be added to the carbonaceous sheared nano-leaves particles at various stages of making the products described herein. In other embodiments, the composition may further comprise a binder.

### Dispersions Comprising Carbonaceous Sheared Nano-Leaves Particles

In yet another aspect, the present disclosure also includes dispersions comprising the carbonaceous sheared nano-leaves particles as described herein.

In some embodiments, the weight content of the carbonaceous sheared nano-leaves in the dispersion is equal to or lower than 10 wt %; such as 0.1 wt % to 10 wt %, or 1 wt % to 8 wt %, or 2% to 6 wt %. The dispersion may also further comprise another carbonaceous material, such as natural graphite, primary or secondary synthetic graphite, expanded graphite, coke, carbon black, carbon nanotubes, including single-wall (SWCNT) and multi-wall (MWCNT) carbon nanotubes, carbon nanofibers and mixtures thereof.

The dispersions are typically liquid/solid dispersions. Since carbonaceous materials are typically insoluble in essentially any solvent, the choice of solvent is not critical. Suitable solvents for the dispersion include, but are not limited to water, water/alcohol mixtures, water/dispersing agent mixtures, water/thickener mixtures, water/binder mixtures, water/additional additive(s) mixtures, N-methyl-2-pyrrolidone (NMP), as well as mixtures thereof.

The dispersions as described herein may generally be prepared by suspending a desired amount of the carbonaceous sheared nano-leaves (optionally together with other additives as described above) in a solvent. Alternatively, the dispersions may be prepared by a process for preparing the carbonaceous sheared nanoleaves as described herein, but where the final step (i.e. removal of the solvent and subsequent drying) is omitted. Thus, for the second variant, the expanded graphite precursor material may be suspended in the solvent and subsequently milled as described in more detail elsewhere herein. After milling (and thus generation of the carbonaceous sheared nano-leaves in the dispersion), and optional addition of further additives, the dispersion can then be either stored as is, or employed in downstream uses, e.g. in the preparation of electrode materials and the like.

### Uses and Secondary Products Comprising the Carbonaceous Sheared Nano-Leaves Particles

Yet another aspect of the present invention relates to the use of the carbonaceous sheared nano-leaves particles or the compositions comprising carbonaceous sheared nano-leaves particles as described herein as a filler for polymers, for battery and capacitor electrodes, electrically and/or thermally conductive polymer composite materials such as automotive body panels, brake pads, clutches, carbon brushes, powder metallurgy, fuel cell components, catalyst support, lubricating oils and greases or anticorrosion coatings.

Secondary products comprising the carbonaceous sheared nano-leaves particles or the compositions comprising said carbonaceous sheared nano-leaves particles as described herein represent further aspects of the present invention.

For example, composite materials comprising the carbonaceous sheared nano-leaves particles or the composition comprising said carbonaceous sheared nano-leaves particles as described herein represent another aspect of the present disclosure.

In some embodiments, the composite includes a matrix material comprising a polymeric material, a ceramic material, a mineral material, a wax, or a building material. In particular embodiments, these composites may be used for preparing thermally and/or electrically conductive materials. Exemplary materials comprise, for example, NMC, MnO₂, LED lighting materials, solar panels, electronics (which aid in heat dissipation) or geothermic hoses, floor heating wherein the conductive polymer acts as a heat exchanger, in heat exchangers in general (e.g., for automotive applications), thermal storage systems based on salts (e.g., phase-change materials or low melting salts), thermally conductive ceramics, friction materials for brake pads, cement, gypsum, or clay (e.g., brick for construction), thermostats, graphite bipolar plates, or carbon brushes. Suitable polymeric materials for use in conductive polymers comprising the carbonaceous sheared nano-leaves particles include, for example, a polyolefin (e.g., polyethylene such as LDPE, LLDPE, VLDPE, HDPE, polypropylene such as homopolymer (PPH) or copolymers, PVC, or PS), a polyamide (e.g., PA6, PA6,6; PA12; PA6,10; PA11, aromatic polyamides), a polyester (e.g., PET, PBT, PC), an acrylic or acetate (e.g., ABS, SAN, PMMA, EVA), a polyimide, a thio/ether polymer (e.g., PPO, PPS, PES, PEEK), an elastomer (natural or synthetic rubber), a thermoplastic elastomer (e.g.: TPE, TPO), thermosetting resins (e.g., phenolic resins or epoxy resins), copolymers thereof, or mixtures of any of the foregoing materials.

The loading ratio of the carbonaceous sheared nano-leaves particles may in general vary widely, depending on the desired target value for the thermal conductivity and the requirements in terms of the mechanical stability of the composite polymer. In some embodiments, good results have already been achieved with additions of about 3 to about 5% (w/w), although in other applications the weight ratio of the added carbonaceous sheared nano-leaves particles may be a little higher, such as about 10, about 15, about 20, about 25 or about 30% (w/w). However, it is not excluded that in other embodiments the conductive polymers contain even more than about 30% of the carbonaceous sheared nano-leaves particles, such as about 40, about 50, about 60 or even about 70% (w/w). In some embodiments of the conductive polymer composites, like carbon brushes or bipolar plates, even about 80% (w/w) or about 90% (w/w) loading of the carbonaceous sheared nano-leaves particles may be included in the composite material.

In any event, should electrical conductivity of the polymer also be desired, the concentration of the carbonaceous sheared nano-leaves particles in the final polymer should be adjusted to exceed the so-called percolation threshold, above which the resistivity of the polymer typically decreases exponentially. On the other hand, it should be taken into account that the melt flow index of the composite material typically decreases (i.e. viscosity increases) with increasing graphite content in the polymer. Thus, the graphite content in the composite polymer blend also depends on the maximal viscosity tolerated in the molding process. The melt flow index may be, however, also dependent on the choice of the polymer type.

Another embodiment of this aspect relates to a negative electrode material for batteries, including lithium ion batteries, comprising the carbonaceous sheared nano-leaves particles represents a further embodiment of this aspect of the present disclosure. Yet another, related, embodiment refers to a negative electrode of a battery, including a lithium ion battery, comprising the carbonaceous sheared nano-leaves particles or the composition comprising said carbonaceous sheared nano-leaves particles as described herein as an active material in the negative electrode. For example, a composition comprising a binder and the carbonaceous sheared nano-leaves particles or the composition comprising said carbonaceous sheared nano-leaves particles as described herein could be used to produce a negative electrode employed, e.g., in a lithium ion battery.

In another embodiment, the carbonaceous sheared nano-leaves may be used as a non-active additive (e.g., conductive additive) in a negative and/or positive electrode of a battery, including a lithium ion battery or a primary battery. A primary battery as used herein refers to non-rechargeable batteries, for example zinc-carbon batteries, alkaline batteries, or primary lithium batteries. In one embodiment, the carbonaceous sheared nano-leaves may be used in a silicon active material-containing lithium ion battery. For instance, the sheared nano-leaves may be included as part of a carbon powder matrix in a graphite-silicon negative electrode.

In yet other embodiments, the present disclosure relates to an energy storage device or a carbon brush comprising the carbonaceous sheared nano-leaves particles or the composition comprising said carbonaceous sheared nano-leaves particles as described herein.

An electric vehicle, hybrid electric vehicle, or plug-in hybrid electric vehicle comprising a battery, including a lithium ion battery or a primary battery, wherein the battery comprises the carbonaceous sheared nano-leaves particles or the composition comprising said carbonaceous sheared nano-leaves particles as described herein as an active material in the negative electrode of the battery, or as a conductive additive in the positive electrode of the battery, are other embodiments of this aspect of the present disclosure.

Yet another embodiment of the present disclosure relates to a carbon-based coating, e.g. on particles, wherein said coating comprises the carbonaceous sheared nano-leaves particles or the composition comprising said carbonaceous sheared nano-leaves particles as described herein.

Dispersions comprising the carbonaceous sheared nano-leaves particles or the composition comprising said carbonaceous sheared nano-leaves particles as described herein are yet another embodiment of this aspect of the present disclosure. Such dispersions are typically liquid/solid dispersions, i.e. they also include a “solvent”. Suitable solvents may in some embodiments include water, water/alcohol mixtures, water/dispersing agent mixtures, water/thickener mixtures, water/binder, water/additional additives or N-methyl-2-pyrrolidone (NMP) or mixtures thereof.

The dispersing/wetting agent in such dispersions is preferably selected from PEO-PPO-PEO block copolymers such as Pluronic PE 6800 (BASF AG), ionic dispersants like sulfonates such as Morwet EFW (AkzoNobel), or non-ionic dispersants like alcohol polyethoxylates such as Emuldac AS 25 (Sasol), alkyl polyethers such as Tergitol 15-S-9 (Dow Chemical), polyethylene glycols, or any other dispersants known to skilled persons in the field of pigment dispersion. The dispersant/surfactant typically makes up between about 0.01 wt % and about 10 wt % of the dispersion, and preferably between about 0.1 wt % and about 5.0 wt % of the dispersion, and most preferably between about 0.25 wt % and about 1.0 wt % of the dispersion.

The rheological modifier, thickener, is preferably a polysaccharide such as Optixan 40 or Xanthan Gum (e.g. available from ADM Ingredients Ltd.). Alternative rheological modifiers are inorganic thickeners like phillosilicates such as Bentone EW (Elementis Specialties), or other organic thickeners like carboxy methyl cellulose or cellulose ethers such as Methocel K 15 M (Dow-Wolf), or like polyacrylates such as Acrysol DR 72 (Dow Chemicals), or like polyurethanes such as DSX 1514 (Cognis), or any other thickeners known in the field of pigment dispersion. The rheological modifier typically makes up between about 0.01 wt % and about 25 wt % of the dispersion, and preferably between about 0.1 wt % and about 5 wt % of the dispersion, and most preferably between about 0.25 wt % and about 1.0 wt % of the dispersion.

The binder is preferably a silicate or a polyvinyl acetate such as Vinavil 2428 (Vinavil), or polyurethane such as Sancure 825 (Lubrizol). The binder typically makes up between about 0.01 wt % and about 30 wt %, preferably between 0.1 and 15 wt %, and most preferably between about 1 wt % and about 10 wt % of the dispersion. Additional additives that may be included are pH modifiers like ammonia or amines such as AMP-90 (Dow Chemical) or any other pH modifier known in the art. Other possible additives are defoamer like mineral oils, such as Tego Foamex K3 (Tego) or silicon based such as Tego Foamex 822 (Tego) or equivalent defoamers known in the art. Preservatives/biocides can also be included in the dispersion to improve the shelf life.

### Use of Ground Expanded Graphite as a Lubricant

It has been discovered that the carbonaceous sheared nano-leaves particles described herein can also be employed as a lubricant, either as a dry film lubricant or as an additive in self-lubricating polymers. Moreover, it was found that other ground expanded graphite particles, including the ground expanded graphite agglomerates described in WO 2012/020099 A1 show excellent properties in terms of their lubricating effects.

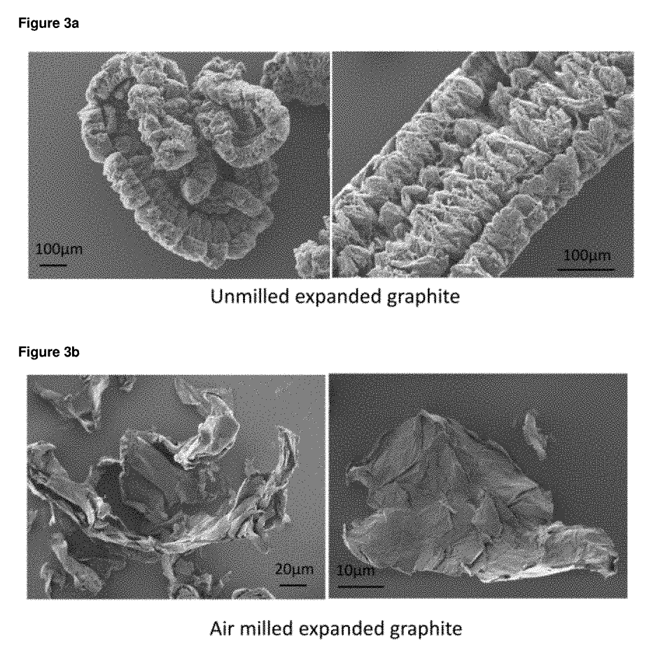

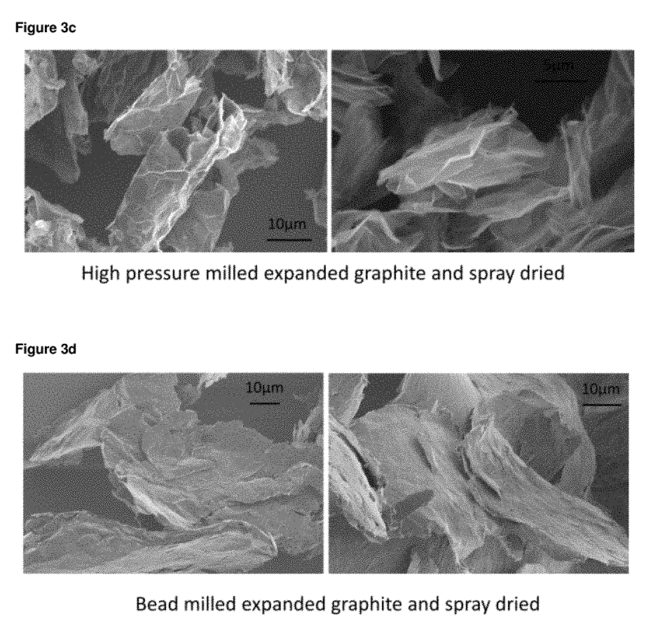

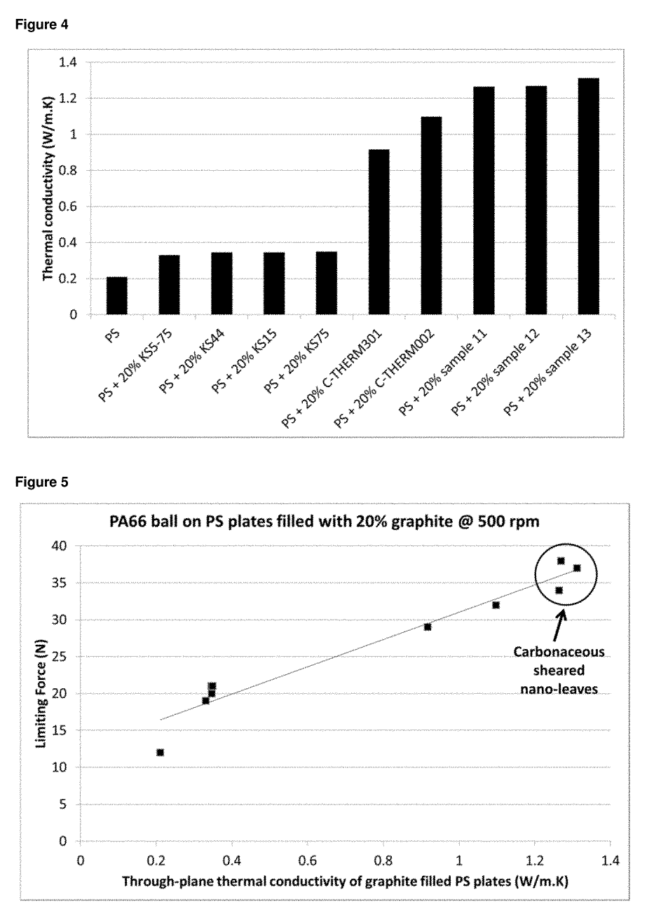

To this end, tribological tests were performed with various polymer composite materials comprising a certain amount (typically 20 wt %) of the carbonaceous sheared nano-leaves as described herein as a (self-lubricating) additive. The inventors found that said composite materials exhibit enhanced tribological properties resulting in low friction coefficients at high normal forces (see Example 3 and FIGS. 3 to 7).

Accordingly, another aspect of the present invention, relates to the use of ground expanded graphite for

(i) increasing the pressure velocity (PV) limit;
(ii) improve the wear resistance; and/or
(iii) decreasing the coefficient of friction of polymer composite materials comprising said ground expanded graphite as an additive, or when used as a dry solid lubricant for moving machine components in engines or other mechanical systems.

The use of ground expanded graphite as a dry lubricant for electrical materials, automobile engines, or metal parts thus represents another embodiment of this aspect of the present disclosure.

In some embodiments of this aspect, the ground expanded graphite is a graphite agglomerate comprising ground expanded graphite particles compacted together, optionally wherein said agglomerates are in granular form having a size ranging from about 100 μm to about 10 mm, preferably from about 200 μm to about 4 mm; preferably wherein the graphite agglomerate defined as in WO 2012/020099 A1, incorporated herein by reference in its entirety. In a specific embodiment, said graphite agglomerates may be further characterized by having a tap density ranging from about 0.08 to about 1.0 g/cm³, preferably from about 0.08 to about 0.6 g/cm³, and more preferably from about 0.12 to about 0.3 g/cm³.

In other embodiments, the ground expanded graphite is a carbonaceous sheared nano-leaves material as described herein. Alternatively, the ground expanded graphite may also be a mixture of the two variants mentioned above.

### Measurement Methods

The percentage (%) values specified herein are by weight, unless specified otherwise.

### Specific BET Surface Area

The method is based on the registration of the absorption isotherm of liquid nitrogen in the range p/p0=0.04-0.26, at 77 K. Following the procedure proposed by Brunauer, Emmet and Teller (Adsorption of Gases in Multimolecular Layers, J. Am. Chem. Soc., 1938, 60, 309-319), the monolayer capacity can be determined. On the basis of the cross-sectional area of the nitrogen molecule, the monolayer capacity and the weight of sample, the specific surface can then be calculated.

### Particle Size Distribution by Laser Diffraction (Wet PSD)

The presence of particles within a coherent light beam causes diffraction. The dimensions of the diffraction pattern are correlated with the particle size. A parallel beam from a low-power laser lights up a cell which contains the sample suspended in water. The beam leaving the cell is focused by an optical system. The distribution of the light energy in the focal plane of the system is then analyzed. The electrical signals provided by the optical detectors are transformed into particle size distribution by means of a calculator. A small sample of graphite is mixed with a few drops of wetting agent and a small amount of water. The sample is prepared in the described manner and measured after being introduced in the storage vessel of the apparatus filled with water that uses ultrasonic waves for improving dispersion. “NMP dispersion X” and “NMP dispersion Y” as described in Example 4 were measured as is.

### References: −ISO 13320-1/−ISO 14887

### Particle Size Distribution by Laser Diffraction (Dry PSD)

The Particle Size Distribution is measured using a Sympatec HELOS BR Laser diffraction instrument equipped with RODOS/L dry dispersion unit and VIBRVL dosing system. A small sample is placed on the dosing system and transported using 3 bars of compressed air through the light beam, typically using lens R5 for materials >75 μm in D90.

### Reference: ISO 13320-1

### Particle Size Distribution by the Acoustic Method (Ultrasonic Attenuation Spectroscopy)

Particle size distributions were measured using an acoustic spectrometer DT-1202 (Dispersion Technology, Inc.). “NMP dispersion X” and “NMP dispersion Y” were measured after having been diluted with water to a solid content of about 0.2 wt. % using a dissolver disc. In the case of carbon black C-NERGY™ SUPER C45 the following procedure to make a water dispersion was used: 0.89 g of wetting agent and 1.50 g of defoamer were dissolved in 300.00 g of water using a dissolver disc, then 6.00 g of carbon black were added to the solution and mixed.

### Xylene Density

The analysis is based on the principle of liquid exclusion as defined in DIN 51 901. Approx. 2.5 g (accuracy 0.1 mg) of powder is weighed in a 25 ml pycnometer. Xylene is added under vacuum (15 Torr). After a few hours dwell time under normal pressure, the pycnometer is conditioned and weighed. The density represents the ratio of mass and volume. The mass is given by the weight of the sample and the volume is calculated from the difference in weight of the xylene filled pycnometer with and without sample powder.

### Reference: DIN 51 901

### Scott Density (Apparent Density or Bulk Density)

The Scott density is determined by passing the dry carbon powder through the Scott volumeter according to ASTM B 329-98 (2003). The powder is collected in a 1 in 3 vessel (corresponding to 16.39 cm³) and weighed to 0.1 mg accuracy. The ratio of weight and volume corresponds to the Scott density. It is necessary to measure three times and calculate the average value. The bulk density of graphite is calculated from the weight of a 250 ml sample in a calibrated glass cylinder.

### Reference: ASTM B 329-98 (2003)

### Crystallite Size L_{c}

Crystallite size L is determined by analysis of the [002] X-ray diffraction profiles and determining the widths of the peak profiles at the half maximum. The broadening of the peak should be affected by crystallite size as proposed by Scherrer (P. Scherrer, Göttinger Nachrichten 1918, 2, 98). However, the broadening is also affected by other factors such X-ray absorption, Lorentz polarization and the atomic scattering factor. Several methods have been proposed to take into account these effects by using an internal silicon standard and applying a correction function to the Scherrer equation. For the present disclosure, the method suggested by Iwashita (N. Iwashita, C. Rae Park, H. Fujimoto, M. Shiraishi and M. Inagaki, Carbon 2004, 42, 701-714) was used. The sample preparation was the same as for the c/2 determination described above.

Crystallite size Lₐ

Crystallite size Lₐ is calculated from Raman measurements using equation:

Lₐ[Angstrom (Å)]=C×(I_{G}/I_{D})

where constant C has values 44 [Å] and 58[Å] for lasers with wavelength of 514.5 nm and 632.8 nm, respectively.

### Electrical Resistivity of Graphite/MnO2 Mixtures

A mixture of 98% electrolytic manganese dioxide (DELTA EMD TA) and 2% of the graphitic material is prepared using a TURBULA mixer. Rectangular-formed samples (10 cm×1 cm×1 cm) are pressed with 3 t/cm². The samples are conditioned for 2 h at 25° C. and a relative humidity of 65%. The electrical resistivity is measured with a 4-points measurement in mΩ cm.

### Electrical Resistivity in Polypropylene

35.08 g of PP HP501L is mixed with 1.46 g of the graphitic material (i.e. 4 wt % carbon nano-leaves, or using the proportional ratio according to the wt % indicated) in an internal mixer at 190° C. for 5 min using 100 rpm and the plaques are prepared by compression moulding.

### Thermal Conductivity Tests in Polystyrene

Thermal conductivity tests were performed in the through-plane direction at room temperature using Laserflash (NETZSCH LFA 447) on discs with a diameter of 25.4 mm and a thickness of 4 mm. Polystyrene (EMPERA 124 N) was mixed with graphite in an internal mixer for 5 min at 220′C and 100 rpm and the plates were prepared by compression moulding.

### Electrical/Thermal Conductivity in a Phenolic Resin

The composite in the phenolic resin has been prepared following the procedure:
Mixing: 80 wt % graphite powder is dry mixed with 20 wt % phenolic resin powder (SUPRAPLAST 101)
Compaction: the mixed powders are pressed in a rectangular mould at different pressures 4 t/cm²
Curing: the pressed samples are cured in an oven according to the following thermal treatment: 25-80° C. (120 minutes), 80-135° C. (660 minutes), 135-180° C. (270 minutes), 120 minutes at 180° C., cooling
   The electrical resistivity is measured with a 4-points measurement in mΩ cm. Thermal conductivity tests were performed in the in-plane direction at room temperature using Laserflash (NETZSCH LFA 447).
   Powder Resistivity @ 4.5 kN/Cm² (2 wt. % Carbon Nano-Leaves in 98 wt. % NMC)

0.2 g of carbonaceous sheared nano-leaves particles and 9.8 g of commercially available Lithium Nickel Manganese Cobalt Oxide (NMC) powder were dispersed in acetone using a high shear energy laboratory mixer, ensuring an adequate homogenization of the powder components. Acetone was removed by drying the samples at 80° C. overnight. 2 g of each dry powder mixture were compressed inside an insulating die (a ring made of glass fiber reinforced polymer having an inner diameter of 11.3 mm and inserted into a larger ring made of steel for additional mechanical support) between two electrified pistons made of brass (diameter: 1.13 cm). The applied force was controlled during the experiment, while the relative position of the pistons in the die (i.e. the height of the powder sample) was measured using a length gauge. The voltage drop across the sample at known, constant current was measured in situ at a pressure of 4.5 kN/cm² using the pistons as the electrodes (2-point resistance measurement). The sample resistance was calculated using Ohm's law, assuming that the contact resistances between pistons and the sample can be neglected (the calculated resistance was ascribed entirely to the sample). The sample resistivity was calculated using the nominal inner diameter of the mold (1.13 cm) and the measured sample height, and expressed in 0-cm. During the experiment the polymeric ring deformed elastically as a consequence of the lateral expansion (transverse strain) of the sample. The elastic deformation of the polymeric ring is almost negligible at pressures equal to or lower than 4.5 kN cm⁻² and can be neglected for comparative purposes.

### REFERENCES

Probst, Carbon 40 (2002) 201-205
Grivei, KGK Kautschuk Gummi Kunststoffe 56. Jahrgang, Nr. September 2003
Spahr, Journal of Power Sources 196 (2011) 3404-3413

### Density and Electrical Resistivity of LiB Positive Electrodes (Cathodes)

0.350 g of carbon conductive additive, i.e. carbon black C-NERGY™ SUPER C65 or carbonaceous sheared nano-leaves particles, previously dispersed in NMP as described elsewhere (Example 4, “NMP dispersion X” and “NMP dispersion Y”), 0.665 g of polyvinylidene difluoride (PVDF) and 33.95 g of Lithium Nickel Manganese Cobalt Oxide (NMC) powder were dispersed in N-methyl-2-pyrrolidone (NMP) using a rotor-stator disperser for some minutes at 11000 rpm (high shear was applied in order to deagglomerate the carbon conductive additive particles and homogeneously distribute them into the dispersion). The PVDF binder had been dissolved in NMP (12 wt. %) before being added to the slurry. The PVP dispersant contained in “NMP dispersion X” and “NMP dispersion Y” was considered to play a role as binder, thus the amount of PVDF was calculated accordingly in order for the total amount of binders (PVDF+PVP) to correspond to 2 wt. % of the solid part of the slurry (carbon, binder and NMC). The slurry was coated onto aluminum foil by doctor blading (wet thickness: 200 μm, loading after drying: 20-27 mg·cm²). The coated foils were dried overnight at 120° C. in vacuum.

The resistance of the coating was measured using a 2-point setup under a force of 20 kN applied on the electrode sample (dameter: 10 mm) using two flat metallic surfaces across which a current of 105 mA was passed and the voltage drop measured. The density and resistivity and were calculated using the sample's weight and dmensions (geometrical area and thickness as measured under applied force by measuring the distance between the two metallic surfaces using a length gauge), taking into account the contributions of the aluminum foil substrate to weight, resistance and thickness (which were measured using the same setup and conditions with an uncoated aluminum electrode sample having the same diameter and subtracted from the corresponding values measured with the coated electrode sample).

### Tribology Tests

Tribology tests were performed on a MCR 302 rheometer (Anton Paar, Graz, Austria) equipped with a tribology cell (T-PTD 200). The setup is based on the ball-on-three-plates principle consisting of a shaft, where a ball is held, and an inset where three small plates can be placed. In the experiments reported herein, the three plates were the carbonaceous material-filled polystyrene (PS) specimen produced via an internal mixer and compression molding, while unhardened steel (1.4401) and polyamide (PA6.6) balls were used for the tribology experiments.

In order to determine the limiting force (i.e. pressure velocity (PV) limit, defined as the normal force at which the friction coefficient exceeds 0.3), tests were performed at a constant rotational speed of 1500 rpm (corresponding to 0.705 m/s) and an increasing normal force (from 1 N to 50 N over 10 min).

### Rheology Measurements

Rheological tests were performed on a MCR 302 rheometer (Anton Paar, Graz, Austria) equipped with a cone-plate setup. “NMP dispersion X” and “NMP dispersion Y” were measured as is (described in Example 4). In the case of comparative carbon blacks, the following general procedure was used to prepare dispersions in NMP: 0.14 g of dispersant (PVP) was slowly dissolved in 48.50 g of NMP using a dissolver disc, then 1.36 g of carbon black was added to the dispersant solution and mixed for 25 minutes at 2500 rpm.

### Solid Content

The solid content was determined using a halogen moisture analyzer (HB43, Mettler Toledo) at 130° C.

### Numbered Embodiments

The present disclosure may be further illustrated by, but is not limited to, the following numbered embodiments:
1. Carbonaceous sheared nano-leaves in particulate form, wherein said carbonaceous sheared nano-leaves are characterized by
   (i) a BET SSA of less than about 40 m²/g, or from about 10 to about 40 m²/g, or from about 12 to about 30 m²/g, or from about 15 to about 25 m²/g, and
   (ii) a bulk density from about 0.005 to about 0.04 g/cm³, or from about 0.005 to about 0.038 g/cm³, or from about 0.006 to about 0.035 g/cm³, or from about 0.07 to about 0.030 g/cm³, or from about 0.008 to about 0.028 g/cm³.
2. The carbonaceous sheared nano-leaves according to embodiment 1, further characterized by
   (i) a particle size distribution having a D₉₀ from about 10 to about 150 μm; and/or
   (ii) a dry PSD D₉₀ to apparent density ratio of about 5000 to 52000 μm*cm³*g⁻¹.
3. The carbonaceous sheared nano-leaves according to embodiment 1 or embodiment 2, further characterized by a thickness, as determined by transmission electron microscopy (TEM), of from about 1 to about 30 nm, or from about 2 to 20 nm, or from 2 to 10 nm.
4. The carbonaceous sheared nano-leaves according to any one of embodiments 1 to 3, further characterized by a xylene density of about 2.1 to 2.3 g/cm³.
5. The carbonaceous sheared nano-leaves according to any one of embodiments 1 to 4, further characterized by
   i) conveying an electrical resistivity to manganese dioxide comprising 2% by weight of said carbonaceous sheared nano-leaves of below about 1000 mΩ cm, preferably below about 800, 700, 600, 500 mΩ cm; and/or
   ii) conveying an electrical resistivity to polypropylene comprising 4% by weight of said carbonaceous sheared nano-leaves of below about 10¹⁰ Ωcm, preferably below about 10⁸, 10⁷, 10⁶ or 10⁵ Ωcm; and/or
   iii) conveying an electrical resistivity to lithium nickel manganese cobalt oxide (NMC) comprising 2% by weight of said carbonaceous sheared nano-leaves of below about 20 n cm, preferably below about 15, 10, 8, 6, or 5 n cm; and/or
   iv) conveying a through plane thermal conductivity to polystyrene (PS) comprising 20% by weight of said carbonaceous sheared nano-leaves of above about 1 W/mK, preferably above about 1.1, 1.2, or 1.25 W/mK; and/or
   v) conveying a friction coefficient to polystyrene (PS) comprising 20% by weight of said carbonaceous sheared nano-leaves of below 0.45, preferably below about 0.40, 0.35, or 0.30 when measured in a “balls-on-three-plates” test with steel balls at 1500 rpm at a normal force of 35 N; and/or
   vi) conveying a limiting force to polystyrene (PS) comprising 20% by weight of said carbonaceous sheared nano-leaves of at least 33 N, or at least 34, 35, 36, or 37 N when measured in a “balls-on-three-plates” test with steel balls at 1500 rpm at increasing normal force.
6. The carbonaceous sheared nano-leaves according to any one of embodiments 1 to 5, obtainable by milling expanded graphite particles in the presence of a liquid (wet milling) and subsequent drying of the dispersion.
7. The carbonaceous sheared nano-leaves according to any one of embodiments 1 to 6, wherein said carbonaceous sheared nano-leaves are agglomerated, preferably wherein the agglomerated nano-leaves are characterized by a bulk density from about 0.1 to about 0.6 g/cm³, or from about 0.1 to about 0.5 g/cm³, or from about 0.1 to about 0.4 g/cm³, and/or a PSD with a D₉₀ of between about 50 μm to about 1 mm, or from about 80 to 800 μm, or from about 100 to about 500 μm.
8. A process for making carbonaceous sheared nano-leaves in particulate form as defined in any one of embodiments 1 to 7, comprising:
   a) mixing expanded graphite particles with a liquid to give a pre-dispersion comprising expanded graphite particles;
   b) subjecting the pre-dispersion obtained from step a) through a milling step;
   c) drying the carbonaceous sheared nano-leaves particles obtained from milling step b).
9. The process according to embodiment 8, further comprising prior to steps a) to c), subjecting a non-expanded carbonaceous material to a mixing and milling step as defined in steps a) and b), and subsequently expanding said milled carbonaceous material.
10. The process according to embodiment 8 or embodiment 9, wherein the liquid is selected from water, an organic solvent, or mixtures thereof.
11. The process according to any of the embodiment 8 to 10, wherein the pre-dispersion subjected to milling step b) further comprises a dispersant, optionally wherein the dispersant is selected from PEO-PPO-PEO block copolymers, sulfonates, or non-ionic alcohol polyethoxylates, alkyl polyethers, or polyethylene glycols.
12. The process according to any of the embodiments 8 to 11, wherein the wet milling step b) is carried out in a planetary mill, a bead mill, a high pressure homogenizer, or a tip sonicator.
13. The process according to any of the embodiments 8 to 12, wherein additional solvent is added before step c), to dilute the processed expanded graphite dispersion.
14. The process according to any of the embodiments 8 to 13, wherein the drying is accomplished by a drying technique selected from the group consisting of subjecting to hot air in an oven/furnace, spray drying, flash or, fluid bed drying, fluidized bed drying and freeze or vacuum drying.
15. The process according to any of the embodiments 8 to 14, wherein drying step c) is conducted at least twice, preferably wherein the drying step comprises at least two different drying techniques.
16. The process according to any of the embodiments 8 to 15, wherein the weight content of the expanded graphite in the dispersion subjected to milling step b) is between about 0.2 to 5%.
17. The process according to any of the embodiments 8 to 15, wherein the weight content of the expanded graphite in the dispersion subjected to milling step b) is between about 1% and 10%, and further wherein the dispersion also comprises at least one dispersant.
18. The process according to any of the embodiments 8 to 17, wherein the expanded graphite employed in step a) is characterized by any one of the following parameters
   i) an apparent density of between about 0.003 and about 0.05 g/cm³; and/or
   (ii) a BET SSA from about 20 to about 200 m²/g
19. The process according to any one of embodiments 8 to 18, further comprising compacting the dried carbonaceous sheared nano-leaves obtained from step c to produce agglomerated carbonaceous sheared nano-leaves.
20. Carbonaceous sheared nano-leaves in particulate form as defined in any one of embodiments 1 to 7, obtainable by a process as defined in any one of embodiments 8 to 19.
21. Composition comprising the carbonaceous sheared nano-leaves in particulate form according to any one of embodiments 1 to 7 or 20; optionally together with another carbonaceous material; optionally wherein the carbonaceous material is selected from the group of natural graphite, primary or secondary synthetic graphite, expanded graphite, coke, carbon black, carbon nanotubes, including single-wall (SWCNT) and multi-wall (MWCNT) carbon nanotubes, carbon nanofibers, and mixtures thereof
22. A dispersion comprising the carbonaceous sheared nano-leaves in particulate form according to any one of embodiments 1 to 7 or 20, optionally
   i) wherein the weight content of the carbonaceous sheared nano-leaves in the dispersion is equal to or lower than 10 wt %; and/or
   ii) wherein the dispersion further comprises another carbonaceous material selected from the group of natural graphite, primary or secondary synthetic graphite, expanded graphite, coke, carbon black, carbon nanotubes, including single-wall (SWCNT) and multi-wall (MWCNT) carbon nanotubes, carbon nanofibers and mixtures thereof;
   iii) wherein the dispersion is a liquid/solid dispersion and wherein the solvent is selected from the group consisting of water, water/alcohol mixtures, water/dspersing agent mixtures, water/thickener mixtures, water/binder, water/additional additives, N-methyl-2-pyrrolidone (NMP), and mixtures thereof.
23. A composite material comprising the carbonaceous sheared nano-leaves in particulate form according to any one of embodiments 1 to 7 or 20, or the composition of embodiment 21 and a polymer, NMC, or MnO₂.
24. A negative or positive electrode, a battery, including a lithium ion battery or a primary battery, or a brake pad
   i) comprising the carbonaceous sheared nano-leaves in particulate form according to any one of embodiments 1 to 7 or 20, or the composition of embodiment 21, or
   ii) made with the dispersion of embodiment 22.
25. Use of the carbonaceous graphitic material according to any of the embodiments 1 to 7 or 20, or the composition of embodiment 21, or the dispersion of embodiment 22, as an additive for polymers, electrode materials for batteries, including lithium ion batteries and primary batteries, and capacitors, batteries, including lithium ion batteries, vehicles containing a battery, including a lithium ion battery, or engineering materials, optionally wherein the engineering materials are selected from brake pads, clutches, carbon brushes, fuel cell components, catalyst supports and powder metallurgy parts.
26. Use of ground expanded graphite for
   (i) increasing the pressure velocity (PV) limit;
   (ii) improve the wear resistance; and/or
   (iii) decrease the coefficient of friction
   of polymer composite materials comprising said ground expanded graphite as an additive.
27. Use of ground expanded graphite as a dry lubricant for electrical materials or engineering materials such as brake pads, clutches, carbon brushes, fuel cell components, catalyst supports and powder metallurgy parts.
28. Use of ground expanded graphite as a lubricant according to embodiment 26 or embodiment 27, wherein the ground expanded graphite is
   i) graphite agglomerates comprising ground expanded graphite particles compacted together, preferably wherein said agglomerates are in granular form having a size ranging from about 100 μm to about 10 mm, preferably from about 200 μm to about 4 mm;
   ii) carbonaceous sheared nano-leaves in particulate form as defined in any one of embodiments 1 to 7 or 20; or
   (iii) mixtures of i) and ii).

Having described the various aspects of the present disclosure in general terms, it will be apparent to those of skill in the art that many modifications and slight variations are possible without departing from the spirit and scope of the present disclosure. The present disclosure is furthermore described by reference to the following, non-limiting working examples.

### EXAMPLES

Manufacture and Characterization of Various Carbonaceous Nano-Leaves Materials

### Example 1—General Procedure

A pre-dispersion of an expanded graphite powder with an apparent density of 0.003-0.050 g/cm³ and a BET between 20 and 200 m²/g in water/organic solvent, optionally together with a surfactant additive was prepared with a solids concentration of between 0.5-3 wt %.

The obtained expanded graphite pre-dispersion was then passed continuously through a mill as described herein above (see Table 1 below for details on which mill type was used for each sample). After a predetermined number of passes through the mill, the processed dispersion was collected and subsequently dried either by air drying in an oven/furnace, by spray drying, by flash or fluid bed drying, by fluidized bed drying, by freeze or by vacuum drying.

In some cases, the initial drying step was followed by a second drying technique as specified in Table 1 below and according to the following particular examples:

### Particular Example 1

60 g of expanded graphite are mixed with 1500 g of water and 1500 g of isopropanol and milled continuously in a planetary ball mill for 5 passes using 5 mm ZrO₂ balls. The resulting dispersion was spray dried using 80° C. as outlet temperature after diluting it to a solid content of ca. 0.7 wt % and sample 1 was collected.

### Particular Example 2

8 g of expanded graphite are mixed with 3000 g of water and 8 g of Tergitol 15-S-9 and milled continuously in an ultrasonic mill equipment using a tip sonicator for one hour. The resulting dispersion was spray dried as explained in particular example 1 and further dried in an air oven at 350° C. for one hour after which sample 2 was collected.

### Particular Example 3

60 g of expanded graphite are mixed with 2400 g of water and 600 g of isopropanol and milled continuously in an ultrasonic mill equipment using a tip sonicator for 45 min. The resulting dispersion was spray dried as explained in particular example 1 and sample 3 was collected.

### Particular Example 4

60 g of expanded graphite are mixed with 2400 g of water and 600 g of isopropanol and milled continuously in a high pressure homogenizer at 100, 300, 600 and 1000 bar for 3 passes. The resulting dispersions were spray dried as explained in particular example 1, after diluting it to a solid content of ca. 1 wt %, and Samples 4, 5, 6 and 7 were collected respectively. Sample 4 was subsequently dried in an air furnace at 575° C. for 3 hours and sample 11 was collected.

### Particular Example 5

60 g of expanded graphite are mixed with 2700 g of water and 300 g of isopropanol and milled continuously in a high pressure homogenizer at 100 bar for 1 pass. The resulting dispersion was vacuum dried, freeze dried or dried with a fluidized bed drier (outlet temperature 130° C.) collecting samples 8, 9 and 10 respectively.

### Particular Example 6

93 g of expanded graphite are mixed with 2400 g of water and 600 g of isopropanol and milled continuously in a pearl mill equipment using 2 mm ceramic pearls for 7 passes. The resulting dispersion was spray dried as explained in particular example 1, after diluting it to a solid content of ca. 1 wt %, and Sample 12 was collected. Sample 12 was subsequently dried in an air furnace at 575° C. for 3 hours or in an air oven at 230° C. for 3 hours; samples 13 and 14 were collected respectively.

### Particular Example 7

93 g of expanded graphite are mixed with 2400 g of water and 600 g of isopropanol and milled continuously in a pearl mill equipment using 2 mm ceramic pearls for 7 passes. The resulting dispersion was filtered using a 100 μm metallic filter and dried in an air oven at 120° C. for 3 hours; sample 16 was collected. Subsequently it was further dried in an air furnace at 575° C. for 3 hours and sample 15 was collected.

### Particular Example 8

93 g of expanded graphite are mixed with 1500 g of water and 1500 g of isopropanol and milled continuously in a pearl mill equipment using 0.8 mm ceramic pearls for 5 passes. The resulting dispersion was filtered using a 100 μm metallic filter and dried in an air oven at 120° C. for 3 hours; sample 17 was collected.

### Particular Example 9

60 g of expanded graphite are mixed with 2700 g of water and 300 g of isopropanol and milled continuously in a pearl mill equipment using 2 mm ceramic pearls for 7 passes. The resulting dispersion was dried in a fluid bed drier equipment (outlet temperature 145° C.) collecting sample 18.

The obtained carbonaceous nano-leaves were subsequently characterized in terms of particle size distribution PSD (wet and dry), BET SSA and apparent (i.e. bulk) density. The properties of the materials produced according to the general procedure outlined above are summarized in Table 1 below.

TABLE 1

| | | | | | Apparent |
|---|---|---|---|---|---|
| Sample | | Wet PSD D₉₀ | Dry PSD D₉₀ | BET SSA | density |
| No. | Process | (μm) | (μm) | (m²/g) | (g/cm³) |
| 1 | Planetary mill + spray drying | 85.7 | 237 | 20.2 | 0.013 |
| 2 | Sonication + spray drying + air | 23.3 | | 21.5 | 0.008 |
| | furnace | | | | |
| 3 | Sonication + spray drying | 51.3 | | 21.7 | 0.015 |
| 4 | High pressure + spray drying | 61.1 | 87.3 | 22.3 | 0.013 |
| 5 | High pressure + spray drying | 43.1 | 125 | 22.0 | 0.011 |
| 6 | High pressure + spray drying | 25.9 | 88 | 22.4 | 0.014 |
| 7 | High pressure + spray drying | 16.4 | 416 | 24.8 | 0.014 |
| 8 | High pressure + vacuum drying | 61.8 | | 18.3 | 0.020 |
| 9 | High pressure + freeze drying | 55.1 | | 21.1 | 0.025 |
| 10 | High pressure + fluidized bed | 67.2 | 132.7 | 16.8 | 0.021 |
| | dry | | | | |
| 11 | High pressure + spray drying + | 62.0 | 188.4 | 24.7 | 0.012 |
| | air furnace | | | | |
| 12 | Bead mill + spray drying | 85.7 | 184.5 | 16.6 | 0.017 |
| 13 | Bead mill + spray drying + air | 89.7 | 239.2 | 23.6 | 0.013 |
| | furnace | | | | |
| 14 | Bead mill + spray drying + air | 96.4 | 187.7 | 16.7 | 0.013 |
| | oven | | | | |
| 15 | Bead mill + air furnace | 111.6 | 365 | 22.7 | 0.011 |
| 16 | Bead mill + air oven | 97.6 | 215.1 | 16.5 | 0.023 |
| 17 | Bead mill + air oven | 111.0 | | 15.5 | 0.026 |
| 18 | Bead mill + flash drying | 66.3 | | 17.7 | 0.035 |

### Example 2—Electrical/Thermal Conductivity of Composite Materials Comprising Carbonaceous Sheared Nano-Leaves

The samples produced according to the procedure set out in Example 1 were subsequently added to various matrix materials such as MnO₂, NMC, polypropylene, polystyrene, and a phenolic resin and the resulting composite materials comprising the carbonaceous sheared nano-leaves materials were tested in terms of electrical or thermal conductivity in accordance with the methods detailed in the Methods section hereinabove. The results of these experiments are summarized in Table 2 below.

TABLE 2

| | | Electrical | Electrical | Electrical | | Electrical/thermal |
|---|---|---|---|---|---|---|
| | | Resistivity | Resistivity | Resistivity | Thermal | Conductivity in |
| | | in MnO₂ | in PP | in NMC | Conductivity | resin @4 T/cm² |
| | | (2 wt %) | (4 wt %) | (2 wt %) | in PS | (80 wt %) |
| Sample | Process | (mΩ cm) | (Ω cm) | (Ω cm) | (20 wt %) (W/m K) | (mΩ cm)/(W/m K) |
| 1 | Planetary mill + | 81.4 | 8.7 × 10² | | | |
| | spray drying | | (5 wt %) | | | |
| 2 | Sonication + | 65.2 | 2.9 × 10⁶ | | | |
| | spray drying + | (3 wt %) | (5 wt %) | | | |
| | air furnace | | | | | |
| 3 | Sonication + | 281.0 | 2.0 × 10⁶ | | | |
| | spray drying | | (5 wt %) | | | |
| 4 | High pressure + | 162.2 | 1.0 × 10⁵ | 1.0 | | |
| | spray drying | | | | | |
| 5 | High pressure + | 191.0 | 3.7 × 10⁸ | 1.2 | | |
| | spray drying | | | | | |
| 6 | High pressure + | 277.7 | 8.1 × 10⁹ | 2.6 | | |
| | spray drying | | | | | |
| 7 | High pressure + | 646.2 | >1.0 × 10¹² | 1.5 | | |
| | spray drying | | | | | |
| 8 | High pressure + | 264.1 | | | | |
| | vacuum drying | | | | | |
| 9 | High pressure + | 485.4 | | | | |
| | freeze drying | | | | | |
| 10 | High pressure + | 339.3 | | | | |
| | fluidized bed dry | | | | | |
| 11 | High pressure + | 253.1 | >1.0 × 10¹² | | 1.25 | |
| | spray drying + | | | | | |
| | air furnace | | | | | |
| 12 | Bead mill + | 108.6 | 1.0 × 10⁴ | | 1.25 | |
| | spray drying | | | | | |
| 13 | Bead mill + | 86.5 | 6.0 × 10⁴ | | 1.30 | |
| | spray drying + | | | | | |
| | air furnace | | | | | |
| 14 | Bead mill + | 378.5 | 1.2 × 10⁴ | | | |
| | spray drying + | | | | | |
| | air oven | | | | | |
| 15 | Bead mill + | 473.0 | 3.2 × 10⁶ | | | |
| | air furnace | | (3.5 wt %) | | | |
| 16 | Bead mill + | 137 | 4.4 × 10⁴ | | | |
| | air oven | | | | | |
| 17 | Bead mill + | 68.0 | | | | 0.74/181 |
| | air oven | (3 wt %) | | | | |
| 18 | Bead mill + | 587.3 | | | | |
| | flash dry | | | | | |

### Example 3—Tribology Tests of Composite Materials Comprising Carbonaceous Sheared Nano-Leaves General Procedure

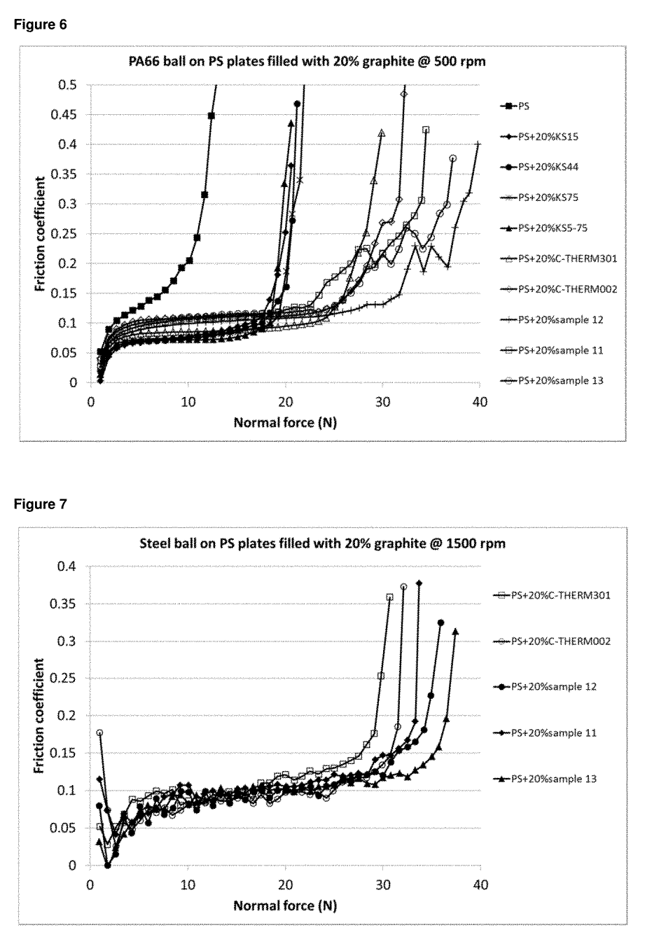

The samples produced according to the procedure set out in Example 1 were subsequently added to polystyrene (20 wt %) and compression-molded. Tribology tests as described in detail in the Methods section using three PS composite plates comprising 20 wt % of selected carbonaceous sheared nano-leaves materials were tested at a constant rotational speed (for example at 500 rpm (corresponding to 0.235 m/s) or 1500 rpm (corresponding to 0.705 m/s) and an increasing normal force (from 1 N to 50 N over 10 min) with unhardened steel or polyamide (PA6.6) balls. The results are illustrated in FIGS. 6 and 7, respectively.

### Example 4:—Preparation and Characterization of Dispersions Comprising Carbonaceous Sheared Nano-Leaves in N-methyl-2-pyrrolidone (NMP)

### General Procedure to Prepare Dispersions:

A) “NMP Dispersion X”

1.19 g of dispersant (polyvinylpyrrolidone, PVP) were slowly dissolved in 283.50 g of N-methyl-2-pyrrolidone (NMP), then 11.86 g of expanded graphite were mixed with the dispersant solution. The resulting dispersion was diluted with some additional NMP, milled continuously in a high pressure homogenizer at 700 bar for 10 min (corresponding to about 6 passes), and subsequently collected.

B) “NMP Dispersion Y”

1.19 g of dispersant (PVP) were slowly dissolved in 283.50 g of NMP, then 11.86 g of expanded graphite were mixed with the dispersant solution. The resulting dispersion was diluted with some additional NMP, milled continuously in a high pressure homogenizer at 300 bar for 5 min (corresponding to about 3 passes), and subsequently collected.

The collected materials were subsequently characterized in terms of their particle size distribution as well as rheological parameters (viscosity) and compared to commercially available carbonaceous materials. Rheological tests were performed on a MCR 302 rheometer (Anton Paar, Graz, Austria) equipped with a cone-plate setup. “NMP dispersion X” and “NMP dispersion Y” were measured as is. In the case of carbon blacks C-NERGY™ SUPER C65 and ENSACO® 350 the following procedure to make NMP dispersions was used: 0.14 g of dispersant (PVP) were slowly dissolved in 48.50 g of NMP using a dissolver disc, then 1.36 g of carbon black were added to the dispersant solution and mixed for 25 minutes at 2500 rpm. The results are summarized in Table 3 below.

TABLE 3

| | | | | | “NMP | “NMP |
|---|---|---|---|---|---|---|
| | | | Super | Ensaco | dispersion | dispersion |
| Material | Instrument | Super C45 | C65 | 350P | X” | Y” |
| Solid Content | | 2.35 | 3 | 3 | 2.48 | 1.98-3.03 |
| of Dispersion | | (measured) | (nominal) | (nominal) | (measured) | (measured) |
| (wt %) | | | | | | |
| Particle Size | Malvern D₁₀ | — | — | — | 4.68 | 5.2 |
| Distribution | Malvern D₅₀ | — | — | — | 146.66 * | 14.54 |
| (PSD) (μm) | Malvern D₉₀ | — | — | — | 324.46 * | 33.66 |
| Particle Size | DT-1202 D₁₀ | 0.10 | — | — | 2.44 | 9.44 |
| Distribution | DT-1202 D₅₀ | 0.15 | — | — | 9.83 | 13.33 |
| (PSD) (μm) | DT-1202 D₉₀ | 0.23 | — | — | 39.69 | 18.83 |
| Viscosity @ | RHEOPLUS | n.d. | 4 | 9 | 4750 | 8140 |
| 12.8 s⁻¹ | MCR302 | | | | | |
| (mPa · s) | | | | | | |

* Possible artifact due to (reversible) agglomeration of the primary particles in the dispersion

### Density and Electrical Resistivity of LiB Positive Electrodes (Cathodes)

The slurry comprising the carbon conductive additive, PVP, PVDF and NMC in NMP (prepared as described above in the “Measurement Methods” section) was coated onto aluminum foil by doctor blading (wet thickness: 200 μm, loading: 20-27 mg·cm²). The coated foils were dried overnight at 120° C. in vacuum.

The resistance of the coating was measured using a 2-point setup as described above in the Materials and Methods section. The results are summarized in Table 4 below.

TABLE 4

| | | | “NMP |
|---|---|---|---|
| Material | Super C65 | “NMP dispersion X” | dispersion Y” |
| Solid Content | — | 2.48 | 1.98-3.03 |
| (wt %) | | | |
| Electrode density | 3.6 | 3.5 | 3.5 |
| (g · cm⁻³) | | | |
| Electrode resistivity | 128 | 25 | 24 |
| (Ω · cm) | | | |

1. Carbonaceous sheared nano-leaves in particulate form, wherein said carbonaceous sheared nano-leaves have
(i) a BET SSA of less than about 40 m²/g, or from about 10 to about 40 m²/g, and
(ii) a bulk density from about 0.005 to about 0.04 g/cm³; and further have
(iii) a particle size distribution having a D₉₀ from about 10 to about 150 μm;
and/or
(iv) a dry PSD D₉₀ to apparent density ratio of about 5000 to 52000 μm*cm³*g⁻¹; and/or
(v) a thickness, as determined by transmission electron microscopy (TEM), of from about 1 to about 30 nm, or from about 2 to 20 nm, or from 2 to 10 nm;
and/or
(vi) a xylene density of about 2.1 to 2.3 g/cm³.

2. Carbonaceous sheared nano-leaves according to claim 1, further
i) conveying an electrical resistivity to manganese dioxide comprising 2% by weight of said carbonaceous sheared nano-leaves of below about 1000 mΩ cm; and/or
ii) conveying an electrical resistivity to polypropylene comprising 4% by weight of said carbonaceous sheared nano-leaves of below about 10¹⁰ Ωcm; and/or
iii) conveying an electrical resistivity to lithium nickel manganese cobalt oxide (NMC) comprising 2% by weight of said carbonaceous sheared nano-leaves of below about 20 Ωcm; and/or
iv) conveying a through plane thermal conductivity to polystyrene (PS) comprising 20% by weight of said carbonaceous sheared nano-leaves of above about 1 W/mK; and/or
v) conveying a friction coefficient to polystyrene (PS) comprising 20% by weight of said carbonaceous sheared nano-leaves of below 0.45 when measured in a “balls-on-three-plates” test with steel balls at 1500 rpm at a normal force of 35 N; and/or
vi) conveying a limiting force to polystyrene (PS) comprising 20% by weight of said carbonaceous sheared nano-leaves of at least 33 N when measured in a “balls-on-three-plates” test with steel balls at 1500 rpm at increasing normal force.

3. Carbonaceous sheared nano-leaves according to claim 1, comprising wet-milled expanded graphite particles.

4. Carbonaceous sheared nano-leaves according to claim 1 wherein said carbonaceous sheared nano-leaves are agglomerated and wherein the agglomerated nano-leaves have
a bulk density from about 0.1 to about 0.6 g/cm³, and/or
a PSD with a D₉₀ of between about 50 μm to about 1 mm.

5. A process for making carbonaceous sheared nano-leaves in particulate form, comprising:
a) mixing expanded graphite particles with a liquid to give a pre-dispersion comprising expanded graphite particles;
b) subjecting the pre-dispersion obtained from step a) through a milling step;
c) drying the carbonaceous sheared nano-leaves particles obtained from milling step b).

6. The process according to claim 5, wherein the liquid is selected from water, an organic solvent, or mixtures thereof.

7. The process according to claim 5, wherein the wet milling step b) is carried out in a planetary mill, a bead mill, a high pressure homogenizer, or a tip sonicator and/or
additional solvent is added before step c), to dilute the processed expanded graphite dispersion; and/or
the drying is accomplished by a drying technique selected from the group consisting of subjecting to hot air in an oven/furnace, spray drying, flash or, fluid bed drying, fluidized bed drying and freeze or vacuum drying; and/or
the drying step c) is conducted at least twice.

8. The process according to claim 5, wherein
(i) the weight content of the expanded graphite in the dispersion subjected to milling step b) is between about 0.2 to 50% and the dispersion further comprises at least one dispersant; and/or
(ii) the expanded graphite employed in step a) is characterized by any one of the following parameters
(a) an apparent density of between about 0.003 and about 0.05 g/cm³; and/or
(b) a BET SSA from about 20 to about 200 m²/g.

9. The process according to claim 5, further comprising compacting the dried carbonaceous sheared nano-leaves obtained from step c to produce agglomerated carbonaceous sheared nano-leaves.

10. Carbonaceous sheared nano-leaves in particulate form obtained by a process as defined in claim 8.

11. A composition comprising carbonaceous sheared nano-leaves in particulate form according to claim 1 and either:
another carbonaceous material; or
a polymer, NMC, or MnO₂.

12. A dispersion comprising the carbonaceous sheared nano-leaves in particulate form according to claim 1, wherein:
i) the weight content of the carbonaceous sheared nano-leaves in the dispersion is equal to or lower than 10 wt %; and/or
ii) the dispersion further comprises another carbonaceous material selected from the group of natural graphite, primary or secondary synthetic graphite, expanded graphite, coke, carbon black, carbon nanotubes, including single-wall (SWCNT) and multi-wall (MWCNT) carbon nanotubes, carbon nanofibers and mixtures thereof;
and/or
iii) the dispersion is a liquid/solid dispersion and wherein the solvent is selected from the group consisting of water, water/alcohol mixtures, water/dispersing agent mixtures, water/thickener mixtures, water/binder, water/additional additives, N-methyl-2-pyrrolidone (NMP), and mixtures thereof.

13. A negative electrode, a lithium ion battery, or a brake pad comprising the carbonaceous sheared nano-leaves in particulate form according to claim 1.

14. A product comprising the carbonaceous graphitic material according to claim 1, wherein the product is an additive for polymers electrode materials for lithium ion batteries and capacitors, lithium ion batteries, vehicles containing a lithium ion battery, or engineering materials, optionally wherein the engineering materials are selected from brake pads, clutches, carbon brushes, fuel cell components, catalyst supports and powder metallurgy parts.

15. A polymer composite material comprising the carbonaceous graphitic material according to claim 1, wherein the polymer composite exhibits:
(i) an Increased pressure velocity (PV) limit;
(ii) an improved wear resistance; and/or
(iii) a decreased coefficient of friction.

16. A dry lubricant comprising:
i) the carbonaceous sheared nano-leaves in particulate form according to claim 1;
ii) graphite agglomerates comprising ground expanded graphite particles compacted together;
or
(iii) mixtures of i) and ii).

17. The process according to claim 5, the pre-dispersion subjected to milling step b) further comprises a dispersant selected from PEO-PPO-PEO block copolymers, sulfonates, or non-ionic alcohol polyethoxylates, alkyl polyethers, or polyethylene glycols.

18. A dispersion comprising the carbonaceous sheared nano-leaves in particulate form according claim 1, wherein the weight content of the expanded graphite in the dispersion is up to 10 wt %.

19. A product comprising the carbonaceous graphitic material according to claim 1, wherein the product is an additive for use in brake pads, clutches, carbon brushes, fuel cell components, catalyst supports, or powder metallurgy parts.
